(19) United States
(12) Patent Application Publication
(10) Pub. No.: US 2017/0024663 A1
(43) Pub. Date: Jan. 26, 2017

(54) CATEGORY RECOMMENDATION USING STATISTICAL LANGUAGE MODELING AND A GRADIENT BOOSTING MACHINE

(71) Applicant: eBay Inc., San Jose, CA (US)

(72) Inventor: Mingkuan Liu, San Jose, CA (US)

(21) Appl. No.: 14/838,865

(22) Filed: Aug. 28, 2015

Related U.S. Application Data
(60) Provisional application No. 62/196,855, filed on Jul. 24, 2015.

(51) Int. Cl. G06N 99/00; G06F 17/30

(52) U.S. Cl. CPC G06N 99/005; G06F 17/30867; G06F 17/3053; G06F 17/30598

(57) ABSTRACT

In accordance with an example embodiment, an input text string is received. Then a k nearest neighbor (KNN) algorithm is used on the input text string to identify a set of leaf categories of an item listing schema that corresponds to the input text string. The set of leaf categories is reordered based on a statistical language model (SLM) algorithm performed on the input text string and an SLM for each leaf category in the set of leaf categories from the KNN recommendation service. A gradient boosting machine (GBM) is then used to fuse the reordered set of leaf categories, a log prior probability for each of the leaf categories, and scores for the KNN algorithm for each of the leaf categories to calculate an ordered list of recommended leaf categories with corresponding scores.

### PRIORITY

This patent application is a non-provisional of and claims the benefit of priority, to U.S. Provisional Patent Application Ser. No. 62/024,862, filed Jul. 15, 2014, which is incorporated herein by reference in its entirety.

### TECHNICAL FIELD

Embodiments of the present disclosure relate generally to gradient boosting machines and, more particularly, but not by way of limitation, to category recommendation using statistical language modeling and a gradient boosting machine.

### BACKGROUND

Category recommendation involves receiving a set of keywords and providing an ordered list of relevant leaf categories corresponding to the set of keywords. Category recommendation is often used to aid listing of items in auctions or online businesses. Properly categorizing an item listed for sale helps potential buyers find the items during browsing sessions or searches. However, it can often be difficult for sellers or other item listers to properly categorize an item, especially when they are not familiar with all of the possible categories (e.g., leaf categories) available. For example, a seller may know that the item they are selling is a book, and may be able to select the general category of book as an item category, but may not know that a deeper category of 19th century historical fiction books is available. Accuracy in category recommendation, however, is a common issue. In order for the recommendations to be useful, the recommendations should be accurate, but achieving that accuracy in systems with large amounts of leaf categories is challenging from a technical standpoint.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating the listing system of FIG. 1 in more detail, in accordance with an example embodiment.

FIG. 3 is a block diagram illustrating the category recommendation component of FIG. 2 in more detail.

FIG. 4 is a block diagram illustrating the Statistical Language Model (SLM) re-ranking module of FIG. 3 in more detail.

FIG. 5 is a block diagram illustrating a system that produces the Log Prior Probability (LPP) for each leaf category and the SLMs for each leaf category of FIG. 3, in accordance with an example embodiment.

FIG. 6 is a block diagram illustrating a system that produces the Gradient Boosting Machine (GBM) models grouped by metadata of FIG. 3, in accordance with an example embodiment.

FIG. 7 is a flow diagram illustrating a method for using a gradient boosting machine to recommend categories for a listing, in accordance with an example embodiment.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, SLM is used to improve accuracy of category recommendations. SLM is a data-driven modeling approach that attempts to qualify the likelihood of a given text input, such as a sentence, listing title, or search query. SLM is able to leverage vast amounts of unsupervised text data (e.g., text data that is unlabeled and thus does not have obvious structure). In an example embodiment, SLM is used to train a language model for each leaf category (leafCat) based on an unsupervised item listing title, and then a new listing's title's sentence log probability is evaluated using the appropriate leaf category's language model. This may be repeated for each candidate leaf category. In one example embodiment, this process is used as a re-ranking process for a ranking of suggested categories calculated using another method.

Additionally, in an example embodiment, a GBM is used to combine predictions of several estimators in order to further refine the suggested categories, fusing together SLM re-ranking scores, k nearest neighbor re-ranking scores (which will be described in more detail below), and other possible re-ranking signals to create an accurate and robust classifier.

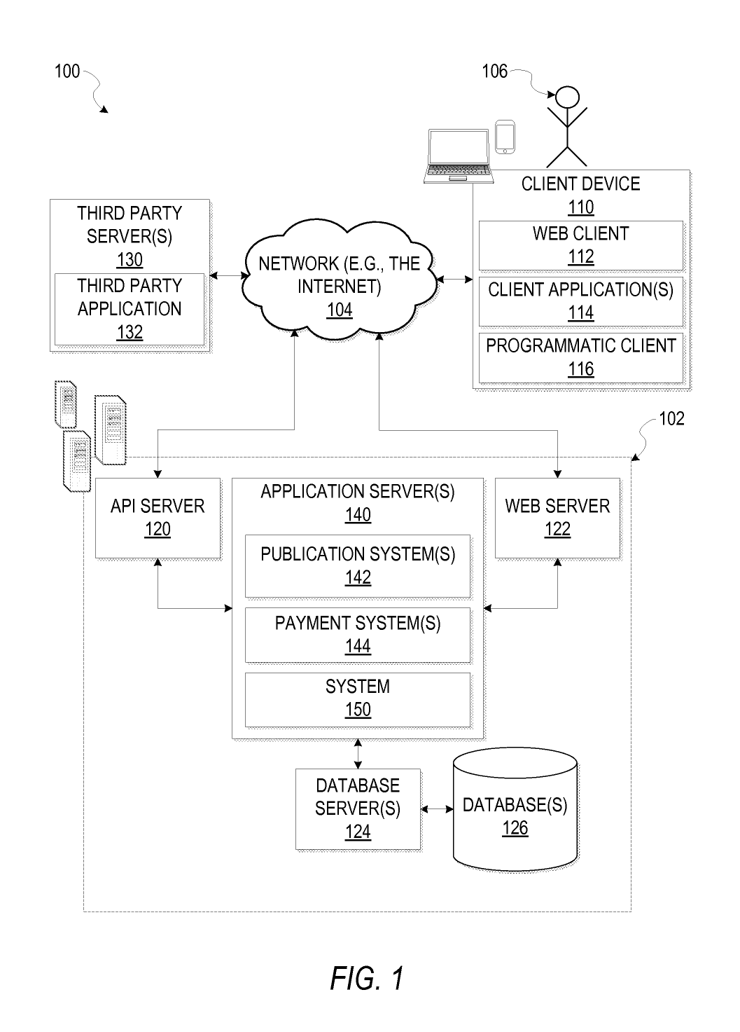

With reference to FIG. 1, an example embodiment of a high-level client-server-based network architecture 100 is shown. A networked system 102, in the example forms of a network-based publication or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), a client application 114, and a programmatic client 116 executing on client device 110.

The client device 110 may comprise, but are not limited to, a mobile phone, desktop computer, laptop, personal digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more portions of the network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital item information, in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

A listing system 150 provides functionality operable to perform various aspects of listing items for sale using the user selected data. For example, the listing system 150 may access the user selected data from the databases 126, the third party servers 130, the publication system 120, and other sources. In some example embodiments, the listing system 150 analyzes the user data to perform personalization of user preferences. As more content is added to a category by the user, the listing system 150 can further refine the personalization. In some example embodiments, the listing system 150 communicates with the publication systems 120 (e.g., accessing item listings) and payment system 122. In an alternative embodiment, the listing system 150 is a part of the publication system 120.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and listing system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 132, executing on a third party server(s) 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

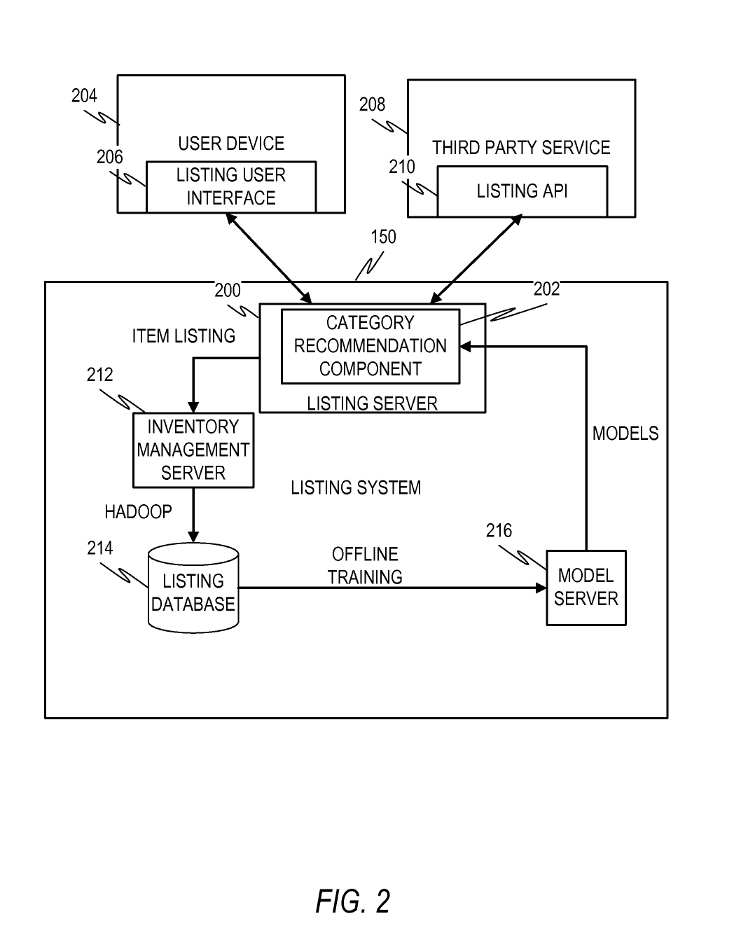

FIG. 2 is a block diagram illustrating the listing system 150 of FIG. 1 in more detail, in accordance with an example embodiment. Here, the listing system 150 includes a listing server 200 which acts to perform back end processes related to the listing of items. The listing system 150 includes, among other components, a category recommendation component 202. User device 204 may be used directly by a user to list an item for sale by interacting with a listing user interface 206 to provide details of the item for listing. The listing user interface 206 communicates this information to the listing server 200. This process may be interactive in nature. For example, certain inputs by the user, via the listing user interface 206, are transmitted to the listing server 200, at which point the listing server 200 provides feedback, which can then cause the user to alter or add to the listing information provided. For purposes of this disclosure, the discussion will be limited to the category recommendation aspect of the listing server 200 as implemented by the category recommendation component 202. Here, a user may enter a title or other text input via the listing user interface 206, which may then be passed to the category recommendation component 202. The category recommendation component 202 can then provide an ordered suggested list of categories for the item listing, which the user can then choose from via the listing user interface 206. This process can occur in a number of ways. In one example embodiment, the user is presented with the top n items in the ordered list, and the user can select a button to see an additional n items in the ordered list. In another example embodiment, scores for each of the suggested categories can be provided, so the user can see the relative confidence in each of the suggested categories instead of just blindly knowing that a particular category is of a higher confidence score. For example, the user learns that the estimated confidence of the 19th century historical fiction category is 95%, whereas the estimated confidence of the 20th century historical fiction category is only 52% despite the 20th century historical fiction category being second in the ordered list, and thus may be more likely to select the 19th century historical fiction category than if the scores were not known.

The listing user interface 206 may take many forms. In one example embodiment, the listing user interface 206 is a web page that is executed by a web browser on the user device 204. In another example embodiment, the listing user interface 206 is a mobile application installed on a mobile device.

The listing server 200 can also be accessed by a third party service 208 via a listing API 210. An example of a third party service 208 is a website that offers to aid sellers in the listing process by listing items on their behalf. The listing API 210 may be specifically designed to interact with the listing server 202 and distributed to multiple third party services 208.

Once a user has selected a category for the listing (due, at least in part, to the category recommendation component 202), the listing server 200 sends the item listing to an inventory management server 212, which manages the process of publishing the listing by storing it in a listing database 214. This may be accomplished via a distributed architecture, such as Hadoop.

A model server 216 may then obtain information about listings from the listing database 214 to perform offline training to create and or modify the models (including leaf category models) that are used by the category recommendation component 202 when recommending the categories to the user.

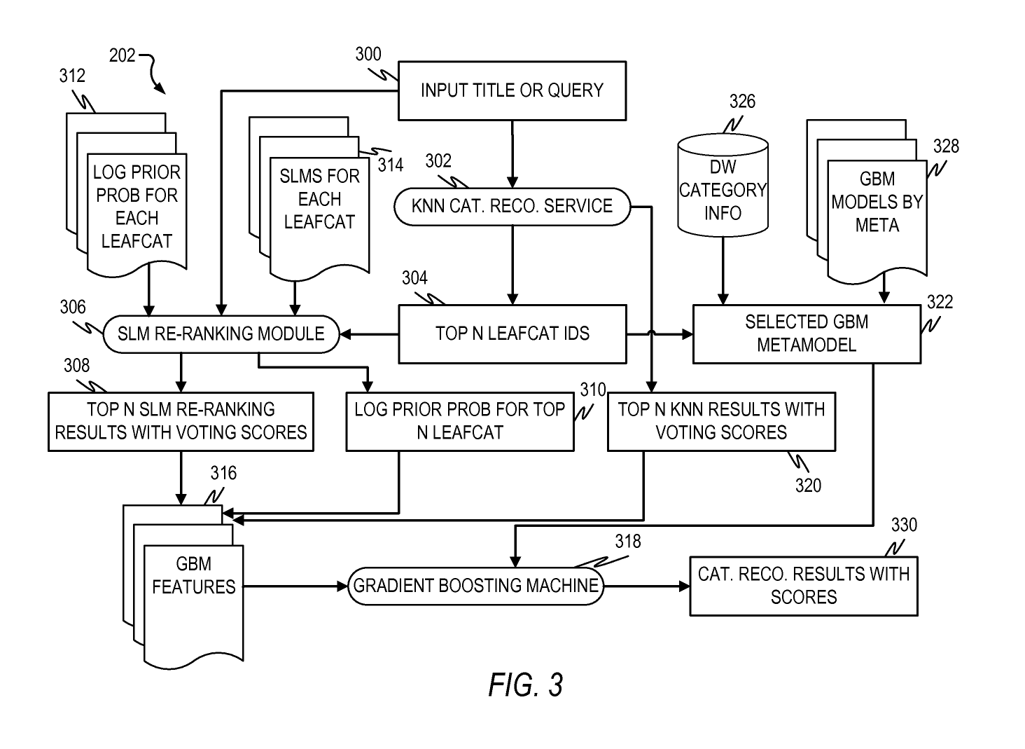

FIG. 3 is a block diagram illustrating the category recommendation component 202 of FIG. 2 in more detail. An input title or query 300 is fed to a K-nearest neighbor (KNN) category recommendation service 302, which calculates the top n leaf category identifications 304 based on a KNN algorithm.

In an example embodiment, the KNN algorithm comprises a training phase and a classification phase. In the training phase, feature vectors and class labels of training samples are stored. In the classification phase, k, which is a user-defined constant, is used, and an unlabeled vector such as a leaf category is classified by assigning the label that is most frequent among the k training samples nearest to the point representing the unlabeled vector. The distance metric for determining the nearest samples may vary based on implementation. For continuous variables, Euclidean distance may be used, but for discrete variables, such as text classification, another metric can be used such as the overlap metric.

In an example embodiment, a rank query is employed for the searching of nearest neighbors. Here, no feature selection is deployed, and instead the rank query inverse document frequency (IDF) scores are used for the actual feature selection. The number of neighbors is fixed and tuned based on testing. An inverse distance voting scheme based on the rank scores returned by the rank query is used to weight the votes by each of the neighbors.

Overall rank score for an item is a sum of the weights of matching keywords from the query in the item title. The weight for a keyword is a rounded integer IDF approximation for that keyword in the index. The IDF approximation for a keyword is computed as log2(number of documents in index)/log2(number of documents in the index with the keyword). For example, if the query is “ipod nano 8 gb” and the item title=“new ipod 8 gb black 4th generation,” then the rank score=W(“ipod”)+W(“nano”)+W(“8”)+W(“gb’) and, for example, W(“ipod”)=log2(number of documents in index)/log2(number of documents in the index with “ipod”).

Inverse distance voting is used to convert the rank scores to a distance/weight metric. For an item “j” V(j)=1/(MaxRankScore−RS(j)+1), where MaxRankScore=max (rank score of all neighbors in the rank query response).

For example, if the MaxRankScore=32, all items with a rank score of 32 will have V(j)=1, all items with rank score of 31 will have V(j)=1/2, all items with rank score of 30 will have V(j)=1/3, and so on.

Each item “j” votes with the voting power of V(j) for its leaf categories. Votes from all the items in the rank query response are tallied, and the leaf categories are recommended in the descending order of their vote scores.

The top n leaf category identifications 304 based on the KNN algorithm are then passed to an SLM re-ranking module 306, which also takes as input the input title or query 300 and uses models to perform a re-ranking of the top n leaf category identifications 304 based on an SLM algorithm, to produce the top n SLM re-ranking results with voting scores 308 and the LPP for top n leaf categories 310. These models include the LPP for each leaf category 312 and the SLMs for each leaf category 314. Notably, in an example embodiment, only the categories listed in the top n leaf category identifications 304 from the KNN category recommendation service 302 are evaluated using the SLM re-ranking module 306. This is significantly more efficient than running the SLM algorithm on all possible categories.

Specifically, the SLM re-ranking module 306 uses the SLMs for each leaf category 314 to calculate the top n SLM re-ranking results with voting scores 308 and uses the LBB for each leaf category 312 to calculate the LPP for top n leaf categories 310.

The top n SLM re-ranking results with voting scores 308, the LPP for top n leaf categories 310, and the top n KNN results with voting scores 320 produced by the KNN category recommendation service 302 are then used to create GBM features 316, which are used by a GBM 318. Additional inputs to the GBM 318 may include a selected GBM metamodel 322, derived from category information 326 and GBM models grouped by metadata 328, and some miscategorization “deep features” described below. The result produced by the GBM 318 is a set of category recommendation results with scores 330.

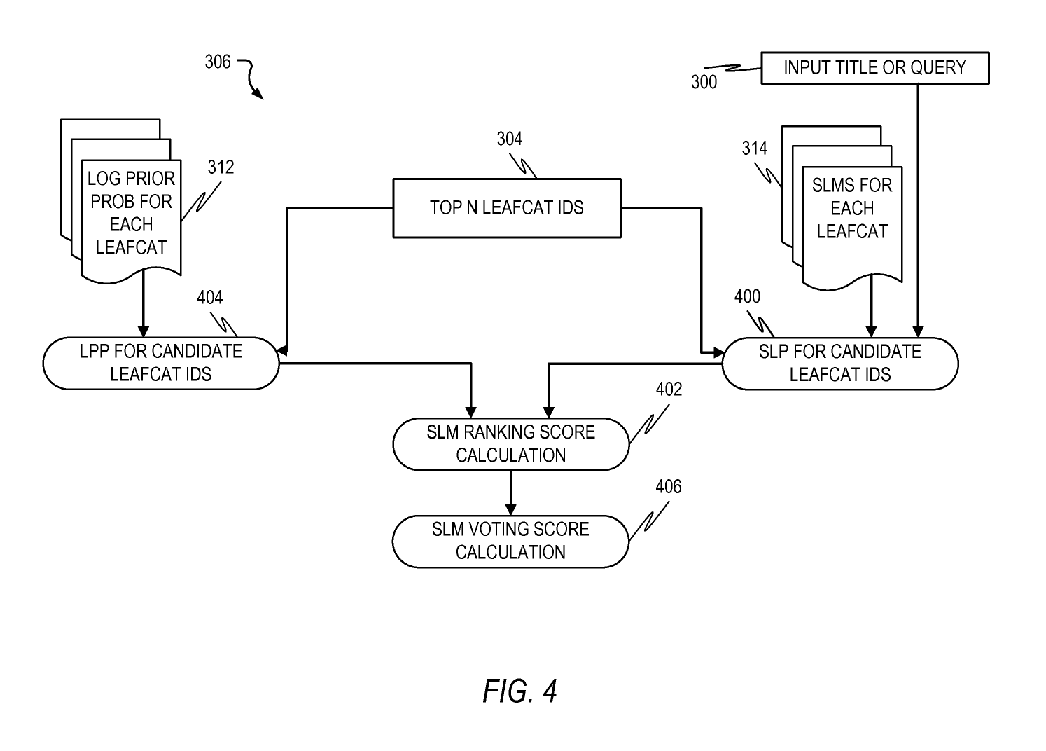

FIG. 4 is a block diagram illustrating the SLM re-ranking module 306 of FIG. 3 in more detail. Here, a Sentence Log Probability (SLP) for candidate leaf category identifications component 400 takes as input the input title or query 300, one of the top n leaf category identifications 304, and the SLMs for each leaf category 314 and performs the SLM's sentence log probability calculation for each category to produce output that is then fed to the SLM ranking score calculation component 402. Likewise, an LPP for candidate leaf category identification component 404 takes as input the top n leaf category identifications 304 and the LPP for each leaf category 312 to produce output fed to the SLM ranking score calculation component 402. The SLM ranking score calculation component 402 then calculates ranking scores for the top n leaf categories and passes this to SLM voting score calculation module 406, which calculates voting scores for each of the top n leaf categories. In an example embodiment, the SLM ranking score (SRS) for each leaf category is calculated by adding together the (weighted) individual SLP scores and LPP scores, such as by using the formula SRS=SLP+1.8*LPP. In an example embodiment, the SLM voting score is calculated by dividing one by the sum of one and the difference between the maximum SRS score and the individual SRS score for a leaf category, such as by using the formula SLM Voting Score=1/(1+Max_SRS−SRS).

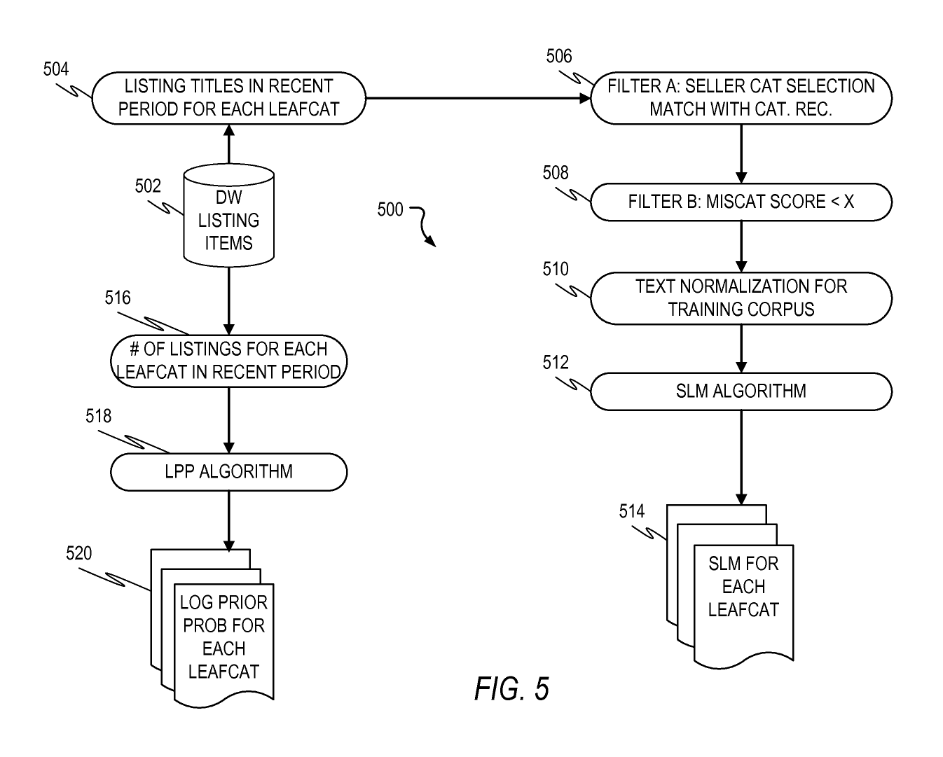

FIG. 5 is a block diagram illustrating a system 500 that produces the LPP for each leaf category 312 and the SLMs for each leaf category 314 of FIG. 3, in accordance with an example embodiment. SLM is a data-driven modeling approach to qualify the likelihood of a given sequence of words such as a query or item title based on categories. The SLM model is a probability distribution of a sequence of words. Given such a sequence, it assigns a probability P (w₁, . . . wₘ) to the whole sequence, assuming a sequence of length m. First, a sentence probability is calculated. The conditional probability of an upcoming word can be calculated using the formula:

P(w_{T}|w₁,w₂, . . . ,wₜ₋₁)

Then the chain rule of probability can be calculated using the formula:

$$P ( {w}_{1} , {w}_{2} , … , {w}_{t - 1} , {w}_{T} ) = {\prod }_{t = 1}^{T} P ( {w}_{t} \vert {w}_{1} , {w}_{2} , … , {w}_{t - 1} )$$

An (n−1)th order Markov assumption can be computed using the formula:

$$P ( {w}_{1} , {w}_{2} , … , {w}_{t - 1} , {w}_{T} ) \approx {\prod }_{t = 1}^{T} P ( {w}_{t} \vert {w}_{t - n + 1} , {w}_{t - n + 2} , … , {w}_{t - 1} )$$

The results are n-grams and word context of n−1 words, such as for example:

$${usb}_{{w}_{t - 5}} {charger}_{{w}_{t - 4}} {for}_{{w}_{t - 3}} {iphone}_{{w}_{t - 2}} {5 c}_{{w}_{t - 1}} {new}_{{w}_{t}} P ( {w}_{t} \vert {w}_{t - 5}^{t - 1} ) = 0.15$$

Parameters are then calculated in the SLP by using a given text corpus, such as using N-Gram Language Model: P(W)

They are generative models of the form:

$$P ( {w}_{1} , {w}_{2} , … , {w}_{t - 1} , {w}_{T} ) \approx {\prod }_{t = 1}^{T} P ( {w}_{t} \vert {w}_{t - n + 1} , {w}_{t - n + 2} , … , {w}_{t - 1} )$$

More generally, Katz back-off language models may be used, such as

P(wₜ|wₜ₋₁, . . . wₜ₋ₙ₊₁)=D*C(wₜ,wₜ₋₁, . . . wₜ₋ₙ₊₁)/C(wₜ₋₁, . . . wₜ₋ₙ₊₁)

or

P(wₜ|wₜ₋₁, . . . wₜ₋ₙ₊₁)=α*P(wₜ|wₜ₋₁, . . . wₜ₋ₙ₊₂)

Where:

C(x)=number of times x appears in training data

D=Good-Turning discounting parameter for wₜ, wₜ₋₁, . . . wₜ₋ₙ₊₁

α=back-off weight (utilized of c(x) not higher than a cut-off threshold)

In an example embodiment, a text format such as arpa is used to store the SLM parameters. In the “arpa” format of the n-gram language model, for a sequence, such as “wood pittsburgh,” one can get its 2-gram probability by reading off:

P(pittsburgh|wood)=0.5555.

And its sentence probability is:

P(wood pittsburgh)=P(wood)*P(pittsburgh|wood)=0.2*0.5555=0.11111

If one does not see the sequence “cindy pittsburgh,” one can get its 2-gram probability by reading off:

P(pittsburgh|cindy)=P(pittsburgh)*BWt(cindy).

And it's sentence probability is:

P(cindy pittsburgh)=P(cindy)*P(pittsburgh|cindy)=P(cindy)*P(pittsburgh)*BWT(cindy)=0.2*0.2*0.5555=0.02222

The parameters may be stored, for example, as follows:

\data\
ngram 1=7
ngram 2=7
\1-grams:
0.1 <UNK> 0.5555
0 <s> 0.4939
0.1 </s> 1.0
0.2 wood 0.5555
0.2 cindy 0.5555
0.2 pittsburgh 0.5555
0.2 jean 0.6349
\2-grams:
0.5555 <UNK> wood
0.5555 <s> <UNK>
0.5555 wood pittsburgh
0.5555 cindy jean
0.5555 pittsburgh cindy
0.2778 jean </s>
0.2778 jean wood
\end\

In an example embodiment, the category recommendation system uses specific algorithm configurations, tuning parameters, and so forth to train the language model. In an example embodiment, a 3-gram word level language model using KN smoothing, Katz-backoff, and the Out of Vocabulary (OOV) token log probability is set to =−7.0.

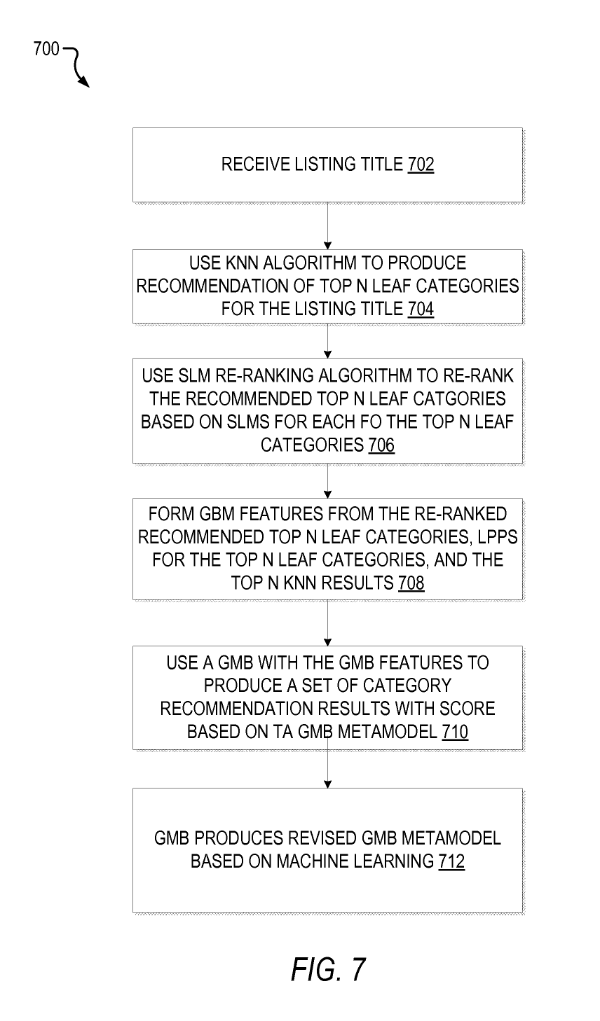

Referring back to FIG. 5, a database 502 containing a listing of items is accessed to obtain the listing titles over a certain period of time (e.g., the last 8 weeks) for each leaf category 504. The listing titles over the certain period of time for each leaf category 504 are then filtered, first using a selection match algorithm 506 that limits the listing titles to just those pertaining to the top n recommended categories and second using a filter 508 that uses a mischaracterization score assigned to each title and filters those titles out that have a mischaracterization score higher than a preset threshold. This mischaracterization score can be calculated, for example, by computing expected perplexity and related standard deviation (STD) for each leaf category's tuning data against the lead category's SLM. Then, the perplexity of the requested title is calculated against its leaf category's SLM model. Based on how far away this perplexity is from the expected perplexity and the STD, a mischaracterization score for this item can be derived as “deep features.” Those mischaracterization deep features can be extra optional input features fed into the GBM 318 part described in FIG. 7's block 708.

A text normalization component 510 then normalizes the text in the titles for a training corpus. This may include, for example, reordering terms in the text or removing superfluous or unnecessary terms (such as articles). The result is then passed to an SLM algorithm 512, which produces an SLM for each leaf category 514.

Additionally extracted from the database 502 is the number of listings for each leaf category in a recent period (e.g., the last 8 weeks) 516. This information is then passed to an LPP algorithm 518, which produces an LPP for each leaf category 520.

A LPP is a type of prior, which is a probability distribution p that would express one's beliefs about this quantity before some evidence is taken into account. It is meant to attribute uncertainty, rather than randomness, to the quantity. The logarithmic prior probability is a uniform prior on the algorithm of proportion. This may be solved, for example, by using the Jeffrey's prior, which is calculated as being proportional to the square root of the determinant of the Fisher information, which is a way of measuring the amount of information that an observable random variable X carries about an unknown parameter θ upon which the probability of X depends.

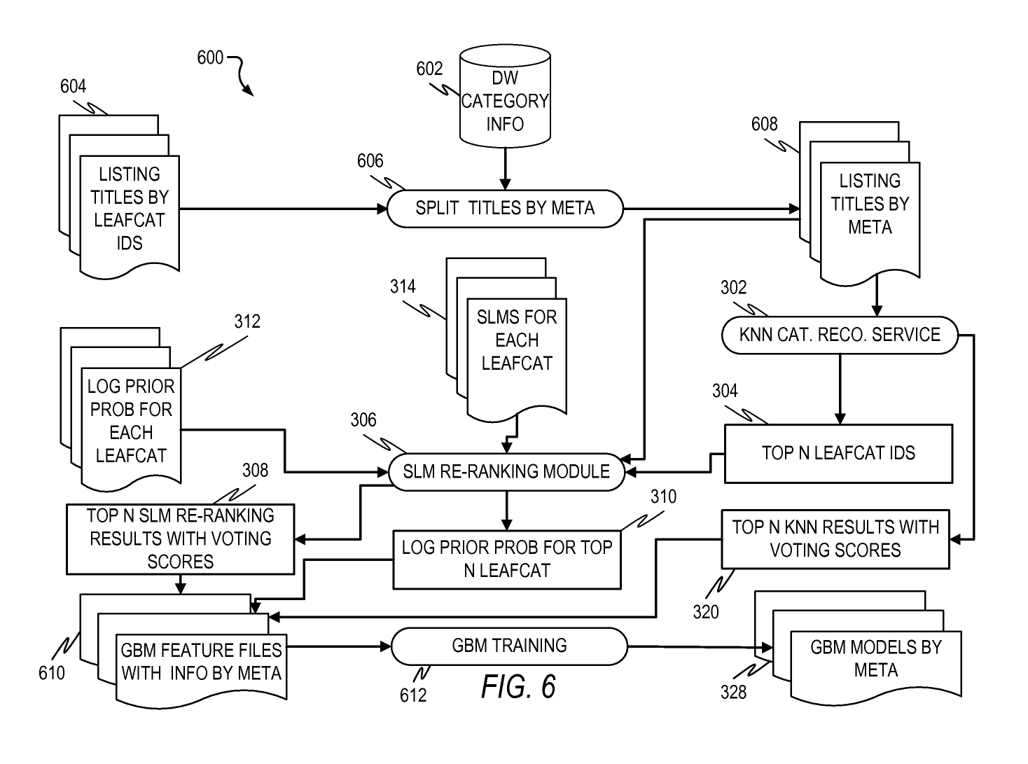

FIG. 6 is a block diagram illustrating a system 600 that produces the GBM models grouped by metadata 326 of FIG. 3, in accordance with an example embodiment. A GBM utilizes an ensemble machine learning technology that combines the predictions of several weak estimators into a powerful ensemble with improved generalizability robustness over a single estimator.

Category information from database 602 and listing titles by leaf category identifications 604 are fed to a split labeled titles by metadata component 606, which splits the labeled titles by metadata and produces documents 608. These documents 608 are then passed to the KNN category recommendation service 302 and the SLM re-ranking module 306. The KNN category recommendation service 302 then produces the top n leaf category identifications 304, which are used by the SLM re-ranking module 306, along with the LPP for each leaf category 312, the SLMs for each leaf category 314, and the listing titles by metadata 608 to produce the log prior probability for the top n leaf categories 310 and the top n SLM re-ranking results with voting scores 308.

The KNN category recommendation service also produces the top N KNN results with voting scores 320. GSM feature files with information grouped by metadata 610 are then formed using the top n SLM re-ranking results with voting scores 308, the LPP prior probabilities for the top n leaf categories 310, and the top n KNN results with voting scores. The GSM feature files with information grouped by metadata 610 are then fed to a GBM training module 612, which creates the GBM models grouped by metadata 328.

GBM produces a prediction model in the form of an ensemble of weak prediction models, and can be used for classification problems by reducing them to regression with a suitable loss function. Here a fusion model is built based on ensemble multiple re-ranking signals to produce a strong and robust classifier in iterative fashion.

FIG. 7 is a flow diagram illustrating a method 700 for using a gradient boosting machine to recommend categories for a listing, in accordance with an example embodiment. At operation 702, a listing title is received. At operation 704, a KNN algorithm is used to produce a recommendation of the top n leaf categories for the listing title. At operation 706, an SLM re-ranking algorithm is used to re-rank the recommended top n leaf categories from the KNN algorithm based on SLMs for each of the top n leaf categories. At operation 708, GBM features are formed from the re-ranked recommended top n leaf categories, LPPs for the top n leaf categories, and the top n KNN results. At operation 710, the GBM features are fed into a GBM, which produces a set of category recommendation results with scores based on a GMB metamodel. At operation 712, the GBM produces a revised GMB metamodel based on machine learning.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

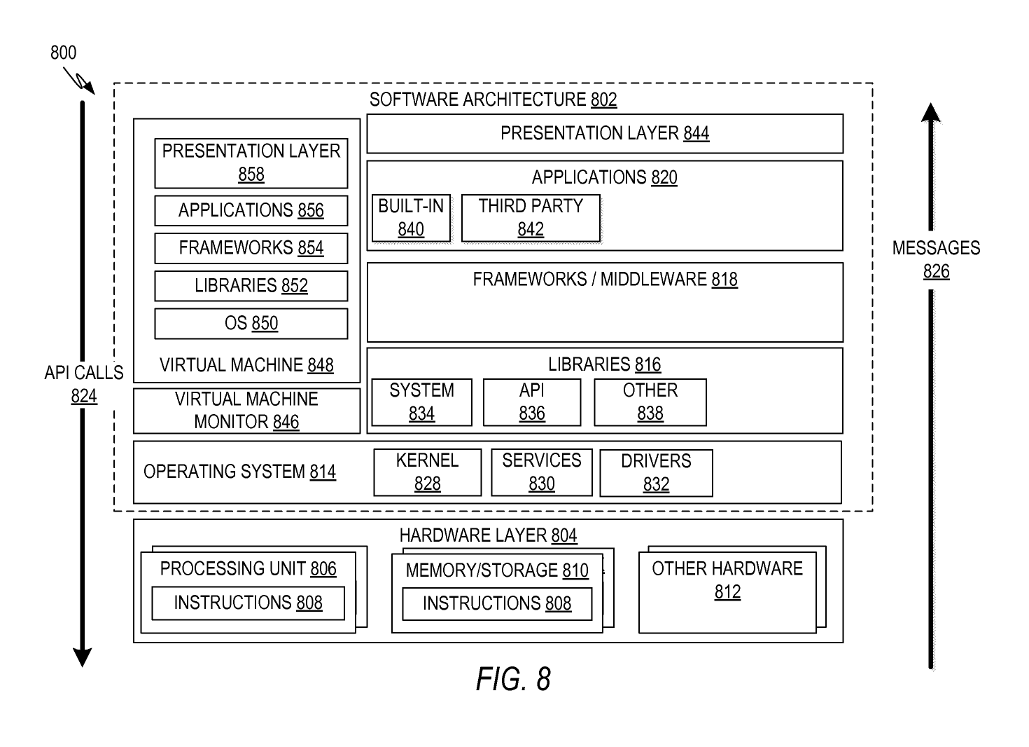

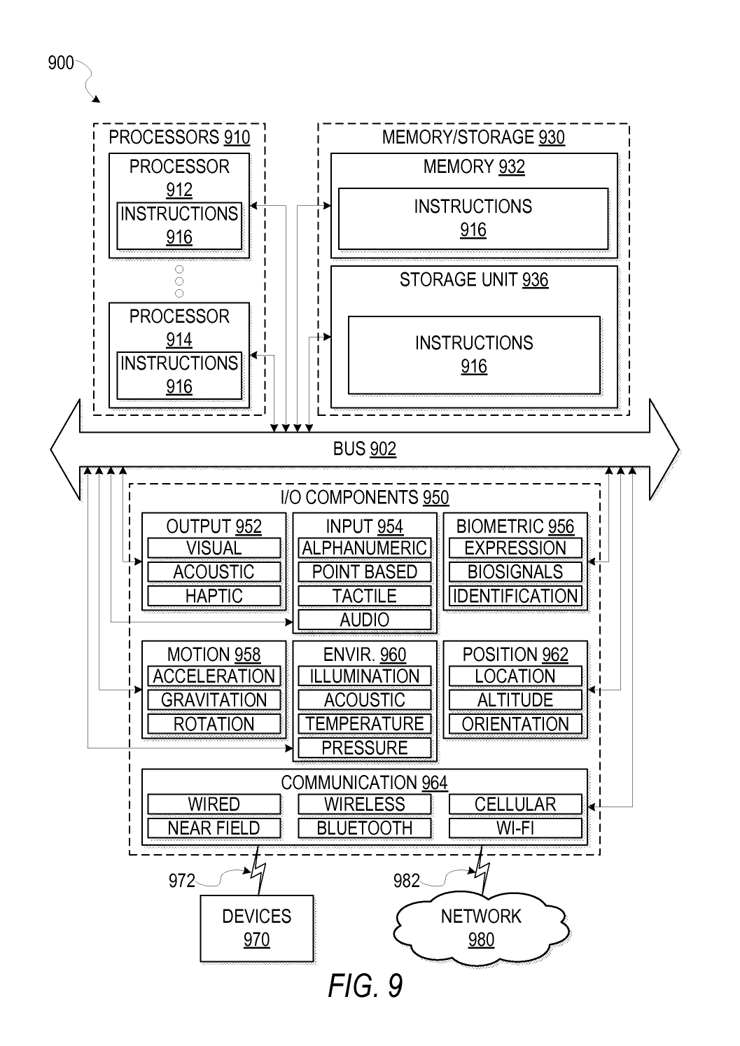

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, modules and so forth of FIGS. 1-7. Hardware layer 804 also includes memory or storage modules 810, which also have executable instructions 808. Hardware layer 804 may also comprise other hardware as indicated by 812, which represents any other hardware of the hardware layer 804, such as the other hardware illustrated as part of machine 900.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 844. Operationally, the applications 820 or other components within the layers may invoke API calls 824 through the software stack and receive a response, returned values, and so forth (illustrated as messages 826) in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830, or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third party applications 842. Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system 834, APIs 836, and other libraries 838), and/or frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine of FIG. 9, for example). A virtual machine is hosted by a host operating system (operating system 814 in FIG. 9) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856, and/or presentation layer 858. These layers of software architecture executing within the virtual machine 848 can be the same as corresponding layers previously described or may be different.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagram of FIG. 7. Additionally, or alternatively, the instructions may implement FIGS. 1-6, and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)), or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a k nearest neighbor (KNN) recommendation service executable by one or more processors and configured to perform a KNN algorithm on an input text string to identify a set of leaf categories of an item listing schema that corresponds to the input text string;
a statistical language model (SLM) re-ranking module configured to reorder the set of leaf categories from the KNN recommendation service based on an SLM algorithm performed on the input text string and an SLM for each leaf category in the set of leaf categories from the KNN recommendation service; and
a gradient boosting machine (GBM) configured to fuse the reordered set of leaf categories, a log prior probability for each of the leaf categories, and scores for the KNN algorithm for each of the leaf categories to calculate an ordered list of recommended leaf categories with corresponding scores.

2. The system of claim 1, wherein the KNN algorithm comprises a training phase and a classification stage, wherein the classification phase uses a user-defined constant k to classify an unlabeled leaf category by assigning a label that is most frequent among k training samples nearest to a point representing the unlabeled vector.

3. The system of claim 2, wherein nearness between training samples and a point is determined using Euclidean distance.

4. The system of claim 2, wherein nearness between training samples and a point is determined using an overlap metric.

5. The system of claim 1, wherein the SLM algorithm comprises determining a sentence log probability (SLP) for each leaf category.

6. The system of claim 1, wherein the SLM algorithm comprises calculating ranking scores for top leaf categories and calculating voting scores for the top leaf categories.

7. A method comprising:
receiving an input text string;
using a k nearest neighbor (KNN) algorithm on the input text string to identify a set of leaf categories of an item listing schema that corresponds to the input text string;
reordering the set of leaf categories based on a statistical language model (SLM) algorithm performed on the input text string and an SLM for each leaf category in the set of leaf categories from the KNN recommendation service; and
using a gradient boosting machine (GBM) to fuse the reordered set of leaf categories, a log prior probability for each of the leaf categories, and scores for the KNN algorithm for each of the leaf categories to calculate an ordered list of recommended leaf categories with corresponding scores.

8. The method of claim 7, wherein the KNN algorithm comprises a training phase and a classification stage, wherein the classification phase uses a user-defined constant k to classify an unlabeled leaf category by assigning a label that is most frequent among k training samples nearest to a point representing the unlabeled vector.

9. The method of claim 8, wherein nearness between training samples and a point is determined using Euclidean distance.

10. The method of claim 8, wherein nearness between training samples and a point is determined using an overlap metric.

11. The method of claim 7, wherein the SLM algorithm comprises determining a sentence log probability (SLP) for each leaf category.

12. The method of claim 7, wherein the SLM algorithm comprises calculating ranking scores for top leaf categories and calculating voting scores for the top leaf categories.

13. The method of claim 12, wherein the calculating voting scores comprises dividing one by the sum of one and the difference between a maximum SLM ranking score and an individual SLM ranking score for a leaf category.

14. A non-transitory machine-readable storage medium having instruction data to cause a machine to perform operations comprising:
receiving an input text string;
using a k nearest neighbor (KNN) algorithm on the input text string to identify a set of leaf categories of an item listing schema that corresponds to the input text string;
reordering the set of leaf categories based on a statistical language model (SLM) algorithm performed on the input text string and an SLM for each leaf category in the set of leaf categories from the KNN recommendation service; and
using a gradient boosting machine (GBM) to fuse the reordered set of leaf categories, a log prior probability for each of the leaf categories, and scores for the KNN algorithm for each of the leaf categories to calculate an ordered list of recommended leaf categories with corresponding scores.

15. The non-transitory machine-readable storage medium of claim 14, wherein the KNN algorithm comprises a training phase and a classification stage, wherein the classification phase uses a user-defined constant k to classify an unlabeled leaf category by assigning a label that is most frequent among k training samples nearest to a point representing the unlabeled vector.

16. The non-transitory machine-readable storage medium of claim 15, wherein nearness between training samples and a point is determined using Euclidean distance.

17. The non-transitory machine-readable storage medium of claim 15, wherein nearness between training samples and a point is determined using an overlap metric.

18. The non-transitory machine-readable storage medium of claim 14, wherein the SLM algorithm comprises determining a sentence log probability (SLP) for each leaf category.

19. The non-transitory machine-readable storage medium of claim 14, wherein the SLM algorithm comprises calculating ranking scores for top leaf categories and calculating voting scores for the top leaf categories.

20. The non-transitory machine-readable storage medium of claim 19, wherein the calculating voting scores comprises dividing one by the sum of one and the difference between a maximum SLM ranking score and an individual SLM ranking score for a leaf category.
